(19) United States
(12) Patent Application Publication
(10) Pub. No.: US 2004/0077250 A1
(43) Pub. Date: Apr. 22, 2004

(54) Method and apparatus for patterning an organic electroluminescence device

(75) Inventors: Toshiyuki Miyadera, Saitama (JP); Akira Hirasawa, Saitama (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/677,251

(22) Filed: Oct. 3, 2003

(30) Foreign Application Priority Data
Oct. 4, 2002 (JP) P2002-292021

(51) Int. Cl. H01J 9/00

(52) U.S. Cl. 445/24

(57) ABSTRACT

Irradiating an organic electroluminescence device with a laser beam to form a luminescent pattern on the organic electroluminescence device. According to the configuration, the forming of the luminescent pattern of the organic electroluminescence device can be achieved at high efficiency and with low cost.

The present disclosure relates to the subject matter contained in Japanese Patent Application No. 2002-292021 filed on Oct. 4, 2002, which is incorporated herein by reference in its entirety.

### BACKGROUND OF THE INVENTION

1. Field of the Invention

The present invention relates to a method and apparatus for patterning an organic electroluminescence device, and a method of producing an organic electroluminescence device.

2. Description of the Related Art

As a thin luminescent device, there is known an organic electroluminescence device (Hereinafter, referred to simply as “organic EL device”). An organic EL device includes a substrate, an anode formed on the substrate, an organic EL layer configured by a plurality of layers stacked on the anode electrode, and a cathode formed on the organic EL layer. The organic EL layer is a layer made of organic material and having at least a luminescent layer.

When a voltage is applied between the anode and the cathode, holes and electrons are injected from the anode and cathode, respectively, into the luminescent layer. The holes and electrons recombine in the luminescent layer to form excitons. The excitons drop to a lower energy level during a very short time period, and a differential energy of part of the excitons between the lower energy level and the excited state is emitted in the form of light. The light emitted in the luminescent layer exits toward the substrate side or the cathode side. As a result, the organic EL device performs as a luminescent device.

When the luminescent pattern of the organic EL device is to have an arbitrary shape, it may be contemplated to employ a technique in which one of members constituting the element, including the electrodes, the luminescent layer, and an insulating layer is formed into a desired shape.

FIG. 7 is a section view of an organic EL device 100 in which a luminescent pattern is formed. In the organic EL device 100, an anode 120 is first grown on a substrate 110 by the vapor deposition method, the sputtering method, or the like. Then, an insulating layer 130 is patterned on the anode 120 by the photolithography method or the like. The pattern formation in forming the insulating layer 130 is performed so that a portion from which light is not to be emitted is covered by the insulating layer 130. Thereafter, an organic EL layer 140 and a cathode 150 are sequentially formed on the anode 120 or the insulating layer 130. As a result, the organic EL device having a desired luminescent pattern is obtained.

FIG. 8 is a section view of an organic EL device 200 in which a luminescent pattern is formed. In the organic EL device 200, an anode 220 having a desired shape is formed on a substrate 210 by the etching method or the like. An organic EL layer 230 and a cathode 240 are sequentially formed on the substrate 210 and the anode 220, thereby obtaining the organic EL device having a desired luminescent pattern.

Another method of forming a luminescent pattern into an arbitrary shape is a method in which a plurality of luminescent elements is arranged in a matrix in a luminescent region. The luminescent elements are configured to emit light independently and only required elements are driven, thereby obtaining a desired luminescent pattern.

In manufacturing the organic EL device 100 or 200, however, the internal structure of the element must be designed for each of luminescent patterns. Therefore, a long time period and much labor are required to obtain an organic EL device having a desired luminescent pattern. As a result, the manufacturing cost of such an organic EL device is increased, and such an organic EL device is not suitable for high-mix low-volume manufacturing.

In the method in which a plurality of luminescent elements arranged in a matrix is formed in a luminescent region, a voltage must be selectively supplied to each of the luminescent elements, and the circuit configuration is therefore become complicated.

In order to form areas of different luminescent brightness in a luminescent region, components such as a driving circuit and a power source must be configured so as to correspond to each of the luminescent brightness. Therefore, the system becomes complicated, and the resulting luminescent element tends to become high in cost.

As an example of a display device which is provided with a plurality of luminescent regions of different luminescent brightness without conducting a brightness adjustment from the outside is disclosed in a Japanese Patent publication JP-A-2001-167881 (specifically, on page from 2 to 3 and in FIG. 2).

According to the publication, a desired luminescent pattern is obtained by irradiating an organic EL device with UV light to modify or break the light-emitting capability. According to the method, a desired luminescent pattern is obtained without conducting a process of placing an insulating layer in the organic EL device, or shaping an electrode. Therefore, the production steps can be simplified.

However, in the method described in the publication, the whole device is irradiated with UV light. In order to obtain a desired luminescent pattern, therefore, the UV irradiation must be conducted after a region not to be irradiated or a luminescent region is masked with a masking member. Therefore, in the method described in the publication, a mask must be previously produced for each of luminescent patterns, and hence the production steps become complicated. Since a mask must be produced for each of luminescent patterns, the manufacturing efficiency is poor, and the manufacturing cost becomes increased. Consequently, the method is not suitable for high-mix low-volume manufacturing.

### SUMMARY OF THE INVENTION

It is therefore an object of the invention to provide an organic EL device having a luminescent pattern formed at high efficiency and with low cost.

In order to achieve the object of the invention, according to a first aspect of the invention, there is provided a method of patterning an organic electroluminescence device, the method including irradiating an organic electroluminescence device with a laser beam to form a luminescent pattern thereon.

According to a second aspect of the invention, there is provided a method of producing an organic electroluminescence device, the method including: forming a first electrode on a substrate; forming an organic electroluminescence layer on the first electrode; forming a second electrode on the organic electroluminescence layer; sealing the first electrode, the organic electroluminescence layer and the second electrode to produce an organic luminescence device having a substantially uniform light emission characteristic; and irradiating the organic luminescence device with a laser beam to form a predetermined luminescent pattern thereon.

According to a third aspect of the invention, there is provided an apparatus for patterning an organic electroluminescence device including a laser irradiation section configured to irradiate an organic electroluminescence device with a laser beam to form a luminescent pattern thereon.

### BRIEF DESCRIPTION OF THE DRAWINGS

The above objects and advantages of the present invention will become more apparent by describing in detail a preferred exemplary embodiment thereof with reference to the accompanying drawings, wherein:

FIG. 1 is a diagram showing an apparatus for patterning an organic EL device according to an embodiment of the invention;

FIG. 2 is a section view showing the structure of the organic EL device;

FIG. 3 is a diagram showing in detail the structure of a laser irradiation section;

FIG. 4 is a view showing the manner of irradiating the organic EL device with a laser beam;

FIG. 5 is a flowchart showing a procedure of patterning the organic EL device by using the patterning apparatus;

FIG. 6 is an exploded perspective view of the organic EL device after the laser beam irradiation;

FIG. 7 is a section view of a conventional organic EL device in which a luminescent pattern is formed; and

FIG. 8 is a section view of another conventional organic EL device in which a luminescent pattern is formed.

### DETAILED DESCRIPTION OF THE PREFERRED EMBODIMENTS

Referring now to the accompanying drawings, there are shown a preferred embodiment of the invention.

FIG. 1 is a diagram showing an apparatus for patterning an organic electroluminescence device (Hereinafter, referred to simply as “organic EL device”) according to an embodiment of the invention. The patterning apparatus 1 irradiates an organic EL device 10 with a laser beam to form a predetermined luminescent pattern on the organic EL device 10.

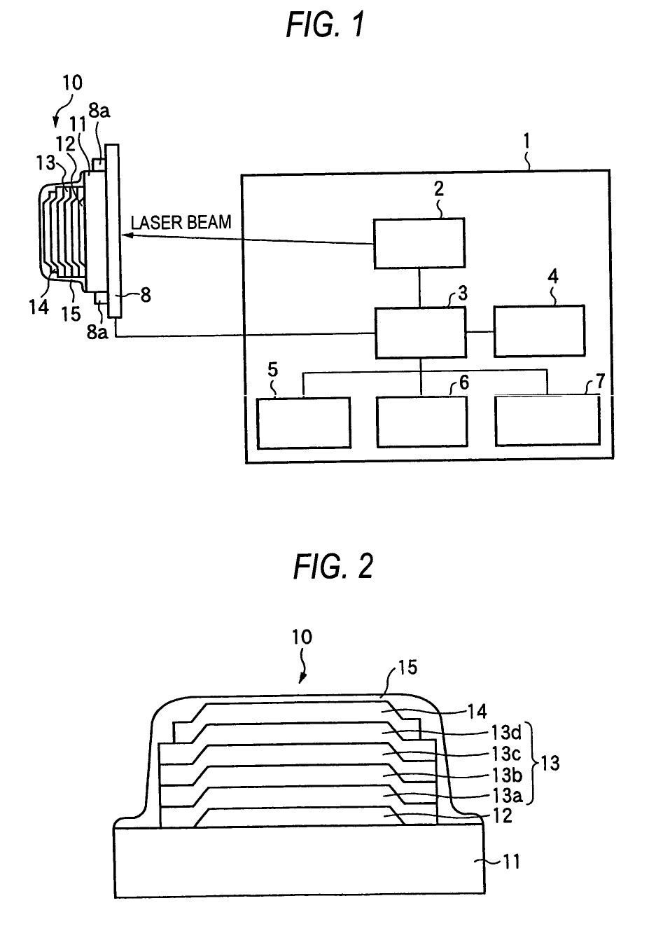

FIG. 2 is a section view showing the structure of the organic EL device 10 to be irradiated with a laser beam. The organic EL device 10 includes: a substrate 11 configured by a transparent material such as glass; an anode 12 formed on the substrate 11; an organic EL layer 13 configured by a plurality of layers stacked on the anode 12; and a cathode 14 formed on the organic EL layer 13. The organic EL layer 13 is a layer made of organic material having at least a luminescent layer.

The organic function layer 13 has a hole-injecting layer 13a, a hole-transporting layer 13b, a luminescent layer 13c and an electron-injecting layer 13d which are sequentially stacked with starting from the side of the anode 12. When a voltage is applied, the hole-injecting layer 13a injects holes into the luminescent layer 13c via the hole-transporting layer 13b, and the electron-injecting layer 13d injects electrons into the luminescent layer 13c. In the luminescent layer 13c, the holes and the electrons recombine to form excitons. The excitons drop to a lower energy level during a very short time period, and a differential energy of part of the excitons between the lower energy level and the excited state is emitted in the form of light. The light emitted in the luminescent layer 13c exits toward the side of the substrate 11 or the side of the cathode 14. As a result, the organic EL device 10 performs as a luminescent element.

The organic EL device 10 is produced by growing the anode 12 on the substrate 11, sequentially growing organic EL layers 13a to 13d on the anode 12, and then growing the cathode 14. After the growth of the cathode 14, a seal layer 15 for sealing the element is grown. The organic EL device 10 is configured to have no particular luminescent pattern, and has a substantially uniform brightness distribution.

The patterning apparatus 1 includes: a laser irradiation section 2 which irradiates the organic EL device 10 with a laser beam; a control section 3; a storage section 4; a data input section 5; a scanner section 6; an external-storage medium read section 7; and an organic EL device fixation section 8.

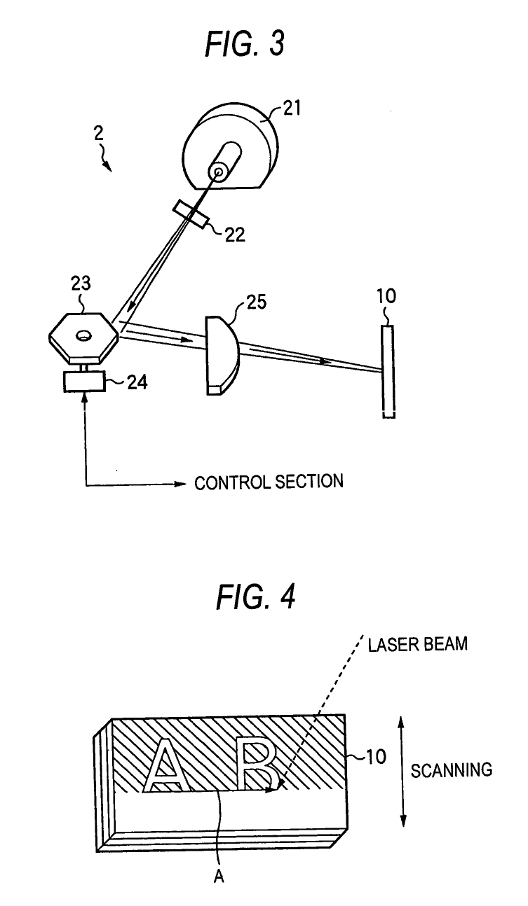

FIG. 3 is a diagram showing in detail the structure of the laser irradiation section 2. The laser irradiation section 2 has a light source 21, a cylindrical lens 22, a polygon mirror 23, a motor 24, an fθ lens 25.

The light source 21 is a semiconductor laser that emits a laser beam of a predetermined wavelength. The laser beam impinges on the organic EL device 10. In the organic EL layer 13 of the organic EL device 10, the resistance of an irradiated portion is increased in accordance with the amount of irradiation of the laser beam, so that the luminescent brightness is reduced or the irradiated portion is not luminescent. In accordance with a control signal from the control section 3, the light source 21 turns ON/OFF the emission of the laser beam. The light source 21 is configured so that the laser beam intensity can be changed in plural steps in accordance with another control signal from the control section 3.

The laser beam emitted from the light source 21 may have any wavelength as far as the resistance of the organic EL layer can be increased by modification or breakage. Particularly, a laser beam of a blue emission wavelength (420 nm or shorter, more preferably 380 nm or shorter) is preferably used because of its high beam energy.

The cylindrical lens 22 converts the laser beam emitted from the light source, into parallel light. The parallel light obtained as a result of the conversion by the cylindrical lens 22 is inputted to the polygon mirror 23.

The polygon mirror 23 is a hexagonal prism shaped mirror in which a mirror surface is formed on each of the six side faces. The polygon mirror 23 is driven by the motor 24 to be rotated at high speed. The laser beam is reflected by the mirror surfaces respectively formed on the side faces. The incident angle of the laser beam to each of the mirror surfaces is continuously changed in accordance with the rotation of the polygon mirror 23, and hence the emission direction of the reflected laser beam is continuously changed according to the angle. As a result, the laser beam scans the organic EL device 10 in one direction in accordance with the change of the emission angle. The laser beam reflected by the polygon mirror 23 is sent to the fθ lens 25.

The motor 24 rotates the polygon mirror 23 in accordance with a control signal from the control section 3.

The fθ lens 25 is a focal lens by which the laser beam reflected from the polygon mirror 23 is constricted so as to be focused on the organic EL device. The fθ lens 25 has an aspheric emission surface, and is configured so that the laser beam is focused on the organic EL device 10 irrespective of the incident angle to the fθ lens 25. On the other hand, the organic EL device 10 is placed at a position where the laser beam is focused by the fθ lens 25.

The storage section 4 is configured by a volatile RAM memory, a nonvolatile hard disk drive, and the like, and stores various data. In accordance with instructions from the control section 3, the storage section 4 stores various data, and reads out data stored in the control section 3. The storage section 4 stores various programs to be implemented by the control section 3.

The data input section 5 is configured by input devices such as a mouse and a keyboard, and a display device. The user operates the input devices such as the mouse and the keyboard to input a luminescent pattern of the organic EL device. The data input section 5 is configured so that predetermined luminescent patterns stored in the storage section 4 are displayed on the display device, thereby enabling the user to select the luminescent pattern which is to be formed on the organic EL device, by using the mouse and the keyboard. The input or selected luminescent pattern is stored into the storage section 4.

The scanner section 6 is an image read section configured by: a scanner which reads an image recorded on a sheet or the like to convert the image into digital data; a digital camera which takes an image of an object to convert the image into digital data; and other devices. The digital data which is obtained by the scanner section 6 is stored as luminescent pattern data into the storage section 4.

The external-storage medium read section 7 is an external-storage section which reads an image, text data, and the like stored on a storage medium. The read data is stored as luminescent pattern data into the storage section 4. The external-storage medium read section 7 is configured by an optical disk reading apparatus such as a CD-ROM drive or a DVD-ROM drive, a magnetic disk reading apparatus such as a floppy disk drive, a magnet-optical disk reading apparatus such as an MO drive, and the like.

The organic EL device fixation section 8 is used for fixing the organic EL device 10 which is to be irradiated with a laser beam, and has fixing projections 8a for fixing the organic EL device 10 onto the organic EL device fixation section 8. In accordance with a control signal from the control section 3, the organic EL device fixation section 8 moves in a direction perpendicular to the scanning direction of the laser beam. The organic EL device fixation section 8 is transparent. The laser beam emitted from the laser irradiation section 2 is transmitted through the organic EL device fixation section 8 and then enters the inside of the organic EL device 10 through the transparent electrode 12.

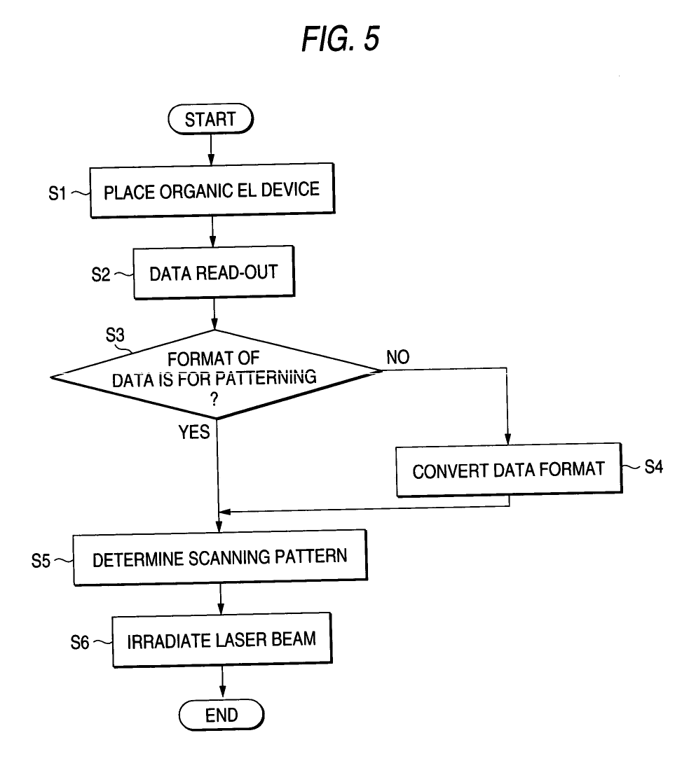

Hereinafter, the patterning of an organic EL device by using the patterning apparatus 1 of the embodiment will be described with reference to FIGS. 4 and 5.

FIG. 5 is a flowchart showing the procedure of patterning the organic EL device 10 by using the patterning apparatus 1. First, the organic EL device 10 is prepared in the following manner. The anode 12 is grown on the substrate 11, the organic EL layers 13a to 13d are sequentially grown on the anode 12, and the cathode 14 is then grown. After the cathode 14 is grown, the seal layer 15 for sealing the element is grown. The organic EL device 10 is configured to have no particular luminescent pattern, and has a brightness distribution substantially uniform over the whole surface. The organic EL device 10 is not required to be produced for each patterning process. A predetermined number of organic EL devices may be previously produced and stocked. In the example, the organic EL devices are used in which ITO, Cu_PC, NPB, Alq₃, Li₂O and A1 are sequentially stacked on a glass substrate and the layers are sealed by an SiN layer.

Next, the organic EL device which is to be subjected to the patterning process is placed on the organic EL device fixation section 8 (step S1), and various settings of the patterning process are conducted. The patterning apparatus 1 first reads data from one of the data input section 5, the scanner section 6, and the external-storage medium read section 7 (step S2). The read data is temporarily stored into the storage section 4 via the control section 3.

Next, the control section 3 checks the data format of the read data, and determines whether the data format is one for patterning or not (step S3). If the data format of the read data is one for patterning, the control proceeds to step S5.

If the data format of the read data is not one for patterning, a program for converting the data format is read out from the storage section 4, and then activated to convert the data format into one for patterning (step S4). Specifically, processes such as those of changing the pixel number of image data to a predetermined number, and converting the number of gradations of each pixel into a predetermined number are performed.

On the basis of the read data, the control section 3 then determines a scanning pattern by which the organic EL device 10 is scanned with a laser beam (step S5). Specifically, the control section calculates emission intensities of the laser beam at positions on the organic EL device respectively corresponding to the pixels of the image data. The control section 3 outputs a control signal corresponding to the scanning pattern to drive the motor 24, thereby rotating the polygon mirror 23. At the same time, the control section 3 outputs a control signal corresponding to the scanning pattern to drive the light source 21 in synchronization with the rotation of the polygon mirror, thereby causing the laser beam to be emitted. The control section 3 supplies a control signal synchronized with the rotation of the polygon mirror, to the organic EL device fixation section 8 to move the organic EL device Fixation section 8 in a direction perpendicular to the scanning direction (the direction of the arrow A shown in FIG. 4) of the laser beam. As a result, the control section 3 performs the control operation so that the organic EL device 10 is irradiated with the laser beam in accordance with the scanning pattern and the predetermined luminescent pattern is formed on the organic EL device (step S6).

FIG. 4 shows the manner of irradiating the organic EL device 10 fixed onto the organic EL device fixation section 8 with the laser beam. In FIG. 4, the blank portions show areas, which are not irradiated with the laser beam, and the hatched portion shows an area which is irradiated with the laser beam.

The laser irradiation section 2 scans the organic EL device in the direction of the arrow A to irradiate the organic EL device with the laser beam of the emission intensity corresponding to the scanning pattern. In accordance with instructions from the control section 3, the organic EL device fixation section 8 moves in a direction perpendicular to the scanning direction (the direction of the arrow A) of the laser beam. As a result, the laser irradiation section 2 irradiates the whole surface of the organic EL device with the laser beam of the emission intensity corresponding to the scanning pattern.

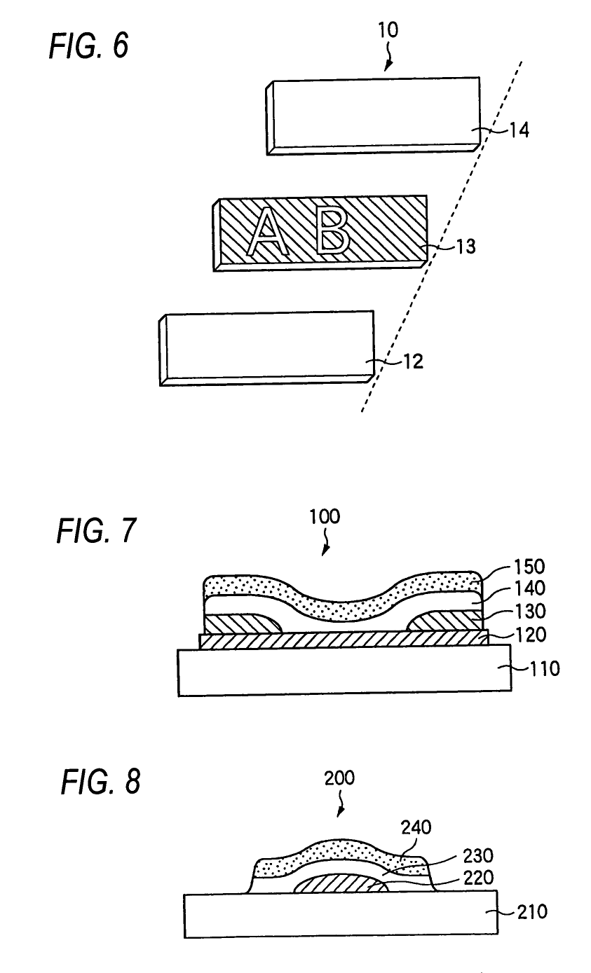

FIG. 6 is an exploded perspective view of the organic EL device 10 after the laser beam irradiation. In the organic EL device 10 of FIG. 6, the blank portions show the areas that are not irradiated with the laser beam, and the hatched portion shows the area which is irradiated with the laser beam, and in which the resistance is increased. When the laser beam irradiation is performed in the way described above, the resistance of the organic EL layer 13 is increased, and the luminescence intensities of the irradiated portions are lowered. When a voltage is applied between the electrodes 12 and 14, therefore, the portion which was not irradiated with the laser beam emits intense light, so that characters such as “AB” are formed on the organic EL device as shown in FIG. 6.

According to the patterning apparatus 1 of the embodiment, the organic EL device 10 is irradiated with a laser beam in accordance with a predetermined pattern to form a luminescent pattern corresponding to the predetermined pattern on the organic EL device 10. Therefore, a luminescent pattern can be formed without causing the organic EL device to have a special element structure, whereby the cost for patterning the organic EL device can be lowered. As a result, high-mix low-volume manufacturing of an organic EL device can be easily achieved.

In the patterning apparatus of the embodiment, a laser beam is used, and hence it is not required to prepare a supplementary member such as a masking member. Therefore, additional process such as those of producing a masking member and placing the masking member on an organic EL device can be eliminated, so that an organic EL device can be efficiently patterned. Consequently, high-mix low-volume manufacturing of an organic EL device is facilitated, and commercial use of an organic EL device is expanded.

In the patterning apparatus of the embodiment, the laser beam scanning is performed by the simple configuration in which the compact semiconductor laser and the polygon mirror are used. Therefore, the size and cost of the apparatus can be reduced.

In the patterning apparatus of the embodiment, since data can be read from the data input section, the scanner section, the external-storage medium read section, and the like, the user can produce a luminescent pattern, and the pattern can be easily read by the patterning apparatus.

When a system using the patterning apparatus of the embodiment is configured, an “a la carte” panel (organic EL display device) can be immediately produced and sold, and pattering of an organic EL device can be commercially available.

In the embodiment, a semiconductor laser is used as the light source. The light source is not restricted to using the semiconductor laser, and may be configured by a device of any kind as far as it can emit a laser beam of a predetermined wavelength to increase the resistance of the organic EL layer. For example, a gas laser, a solid-state excitation laser, or the like may be used.

The wavelength may be set to any value as far as it allows the resistance of the material constituting the organic EL layer to be increased. In a case where an organic EL device having an organic EL layer of a material which has a strong absorption wavelength band in the visible light region, particularly, a laser light source of a wavelength which is in the visible light region may be used.

In the embodiment, a polygon mirror is used for the laser beam scanning. The section for the laser beam scanning is not particularly restricted to this as far as it can perform the laser beam scanning. For example, the irradiation direction of a laser beam may be fixed, and a luminescent pattern may be formed by moving an organic EL device.

In the embodiment, an organic EL device is scanned in accordance with predetermined data. The present invention is not restricted to this configuration. The user may directly operate a laser beam irradiation apparatus so as to perform a scanning operation, or directly move an organic EL device, whereby a luminescent pattern is formed on the organic EL device.

In the embodiment, the laser beam irradiation is performed from the side of the transparent electrode 12. The invention is not restricted to this structure. In the case where the back electrode is optically transparent, the laser beam irradiation may be performed from the side of the back electrode. The organic EL device fixation section 8 is transparent. Alternatively, a light passing opening may be formed in the organic EL device fixation section 8.

In the embodiment, the organic EL device 10 has a structure in which the anode 12 is formed on the substrate 11. However, the organic EL device 10 may also be structured in a layered structure that the anode 12, the organic EL layer 13 and the cathode 14 are disposed on the substrate 11 in opposite order to the structure shown in FIGS. 1 and 2.

Although the present invention has been shown and described with reference to a specific preferred embodiment, various changes and modifications will be apparent to those skilled in the art from the teachings herein. Such changes and modifications as are obvious are deemed to come within the spirit, scope and contemplation of the invention as defined in the appended claims.

What is claimed is:

1. A method of patterning an organic electroluminescence device, the method comprising irradiating an organic electroluminescence device with a laser beam to form a luminescent pattern thereon.

2. The method as claimed in claim 1, wherein the laser beam comprises a laser beam of a blue emission wavelength.

3. A method of producing an organic electroluminescence device, the method comprising:
forming a first electrode on a substrate;
forming an organic electroluminescence layer on the first electrode;
forming a second electrode on the organic electroluminescence layer;
sealing the first electrode, the organic electroluminescence layer and the second electrode to produce an organic luminescence device having a substantially uniform light emission characteristic; and
irradiating the organic luminescence device with a laser beam to form a predetermined luminescent pattern thereon.

4. The method as claimed in claim 3, wherein the laser beam comprises a laser beam of a blue emission wavelength.

5. An apparatus for patterning an organic electroluminescence device comprising a laser irradiation section configured to irradiate an organic electroluminescence device with a laser beam to form a luminescent pattern thereon.

6. The apparatus as claimed in claim 5, wherein the laser irradiation section comprises a semiconductor laser configured to output a laser beam of a blue emission wavelength.

7. The apparatus as claimed in claim 5 further comprising:
a storage section configured to store a predetermined pattern; and
a control section configured to control the laser irradiation section to irradiate the organic electroluminescence device with the laser beam in accordance with the predetermined pattern.

8. The apparatus as claimed in claim 5, wherein the laser irradiation section further comprises:
a light source configured to emit the laser beam; and
a scanning section configured to scan the organic electroluminescence device with the laser beam emitted from the light source.

9. The apparatus as claimed in claim 8, wherein the scanning section comprises a polygon mirror.

10. The apparatus as claimed in claim 7 further comprising a pattern input section configured to input data and store the data in the storage section as the predetermined pattern.

11. The apparatus claimed in claim 10, wherein the pattern input section comprises a data input section configured to be operable by a user to input the data.

12. The apparatus claimed in claim 10, wherein the pattern input section comprises an image scanning section configured to scan an image as the data.

13. The apparatus claimed in claim 10, wherein the pattern input section comprises an eternal-storage section configured to read out data recorded on a recording medium as the data.
